(19) United States
(12) Patent Application Publication
(10) Pub. No.: US 2009/0120085 A1
(43) Pub. Date: May 14, 2009

(54) POWER STEERING APPARATUS

(75) Inventor: Tamotsu YAMAURA, Atsugi-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/266,261

(22) Filed: Nov. 6, 2008

(30) Foreign Application Priority Data
Nov. 9, 2007 (JP) 2007-291408

(51) Int. Cl. B62D 5/06; F15B 9/14; F15B 1/04

(52) U.S. Cl. 60/423; 180/442

(57) ABSTRACT

In a hydraulic power cylinder equipped power steering apparatus, a part of each of first and second hydraulic lines, associated with respective hydraulic chambers of the power cylinder, is constructed by a low-rigidity line functioning as a variable volume hydraulic-line section and formed of an elastically-deformable, flexible tube, made of a synthetic rubber. The line length of the low-rigidity line, which is disposed in each of the first and second hydraulic lines, is dimensioned so that each of an apparent modulus Ke of volume elasticity of working fluid in a first hydraulic pressure transmission path and an apparent modulus Ke of volume elasticity of working fluid in a second hydraulic pressure transmission path is set within a specified apparent volume modulus range, defined by an inequality 100 MPa≦Ke≦300 MPa.

### TECHNICAL FIELD

The present invention relates to a power steering apparatus, and specifically to a hydraulic power cylinder equipped power steering apparatus enabling steering assist force application by operating a hydraulic power cylinder responsively to steering input transmitted through a steering wheel of an automotive vehicle.

### BACKGROUND ART

A power steering device disclosed in Japanese Patent Provisional Publication No. 2006-282021 (hereinafter is referred to as “JP2006-282021”) is generally known as this type of power steering apparatus. The power steering device disclosed in JP2006-282021 is configured so that a pump unit, which is mainly comprised of a reversible oil pump, an electric motor provided to drive the pump, and a reservoir tank for storing working fluid (operating oil), is connected to a hydraulic power cylinder used for steering assist force application. The first suction-and-discharge port of the pump unit is connected through the first hydraulic line to one of a pair of hydraulic chambers defined in the power cylinder, whereas the second suction-and-discharge port of the pump unit is connected through the second hydraulic line to the other hydraulic chamber. An electronic control unit is also provided to control a driving state of the pump (i.e., the oil-pump electric motor) responsively to steering input (steering torque) transmitted through a steering wheel, thereby producing a steering assist force (or a steering assistance torque).

### SUMMARY OF THE INVENTION

In the power steering device disclosed in JP2006-282021, the rigidities of the two hydraulic lines, associated with respective hydraulic chambers of the power cylinder, are not taken into account at all. For instance, in the case of the hydraulic line having an excessively high rigidity, there is a risk of a hydraulic pressure surge (e.g., an unstable hydraulic pressure buildup), thus deteriorating a steering feel. In contrast, the hydraulic line having an excessively low rigidity, leads to the problem of a deterioration in the steering responsiveness to high-frequency steering input. That is, the rigidity of each of the first and second hydraulic lines strongly influences the steering feel. The unsuitable rigidity of the hydraulic line, therefore, gives the driver an uncomfortable steering feel of the steering action. It is would be desirable to prevent a steering feel from being deteriorated during a steering-assist mode due to such an unsuitable rigidity of the hydraulic line through which the pump and the power cylinder are connected to each other.

It is, therefore, in view of the previously-described disadvantages of the prior art, an object of the invention to provide a power steering apparatus, which avoids the aforementioned disadvantages.

In order to accomplish the aforementioned and other objects of the present invention, a power steering apparatus comprises a steering-assist hydraulic power cylinder having a first hydraulic chamber and a second hydraulic chamber divided by a piston, a reversible pump configured to selectively supply working fluid to either one of the first and second hydraulic chambers of the power cylinder, while producing a pump pressure by pressurizing the working fluid, a controller configured to control a driving state of the pump, and a hydraulic circuit comprising a first hydraulic line provided to connect the first hydraulic chamber and a first port of the pump, and cooperated with the first hydraulic chamber to construct a first hydraulic pressure transmission path through which the pump pressure is transmitted to a first pressure-receiving surface of the piston facing the first hydraulic chamber, a second hydraulic line provided to connect the second hydraulic chamber and a second port of the pump, and cooperated with the second hydraulic chamber to construct a second hydraulic pressure transmission path through which the pump pressure is transmitted to a second pressure-receiving surface of the piston facing the second hydraulic chamber, and a variable volume section disposed in each of the first and second hydraulic pressure transmission paths, a volume of the variable volume section being elastically varied responsively to a hydraulic pressure change in the associated hydraulic pressure transmission path, wherein each of an apparent modulus of volume elasticity of working fluid in the first hydraulic pressure transmission path and an apparent modulus of volume elasticity of working fluid in the second hydraulic pressure transmission path is set to a value greater than or equal to 100 MPa, the apparent modulus of volume elasticity of working fluid in the first hydraulic pressure transmission path corresponding to a ratio of a hydraulic pressure change in the first hydraulic pressure transmission path to a rate of change in working fluid quantity in the first hydraulic pressure transmission path, the working fluid quantity change in the first hydraulic pressure transmission path including a change in volume of the first hydraulic pressure transmission path itself, occurring due to the hydraulic pressure change in the first hydraulic pressure transmission path, and the apparent modulus of volume elasticity of working fluid in the second hydraulic pressure transmission path corresponding to a ratio of a hydraulic pressure change in the second hydraulic pressure transmission path to a rate of change in working fluid quantity in the second hydraulic pressure transmission path, the working fluid quantity change in the second hydraulic pressure transmission path including a change in volume of the second hydraulic pressure transmission path itself, occurring due to the hydraulic pressure change in the second hydraulic pressure transmission path.

According to another aspect of the invention, a power steering apparatus comprises a steering-assist hydraulic power cylinder having a first hydraulic chamber and a second hydraulic chamber divided by a piston, a reversible pump configured to selectively supply working fluid to either one of the first and second hydraulic chambers of the power cylinder, while producing a pump pressure by pressurizing the working fluid, a controller configured to control a driving state of the pump, and a hydraulic circuit comprising a first hydraulic line provided to connect the first hydraulic chamber and a first port of the pump, and cooperated with the first hydraulic chamber to construct a first hydraulic pressure transmission path through which the pump pressure is transmitted to a first pressure-receiving surface of the piston facing the first hydraulic chamber, and a second hydraulic line provided to connect the second hydraulic chamber and a second port of the pump, and cooperated with the second hydraulic chamber to construct a second hydraulic pressure transmission path through which the pump pressure is transmitted to a second pressure-receiving surface of the piston facing the second hydraulic chamber, wherein each of the first and second hydraulic pressure transmission paths comprises a high-rigidity line formed of a steel tube, and a low-rigidity line formed of a flexible tube, which is made of a synthetic rubber, and wherein each of a volume ratio of a volume of the low-rigidity line included in the first hydraulic pressure transmission path to a total volume of the first hydraulic pressure transmission path and a volume ratio of a volume of the low-rigidity line included in the second hydraulic pressure transmission path to a total volume of the second hydraulic pressure transmission path is set to a value less than or equal to 40%.

According to a further aspect of the invention, a power steering apparatus comprises a steering-assist hydraulic power cylinder having a first hydraulic chamber and a second hydraulic chamber divided by a piston, a reversible pump configured to selectively supply working fluid to either one of the first and second hydraulic chambers of the power cylinder, while producing a pump pressure by pressurizing the working fluid, a controller configured to control a driving state of the pump, and a hydraulic circuit comprising a first hydraulic line provided to connect the first hydraulic chamber and a first port of the pump, and cooperated with the first hydraulic chamber to construct a first hydraulic pressure transmission path through which the pump pressure is transmitted to a first pressure-receiving surface of the piston facing the first hydraulic chamber, and a second hydraulic line provided to connect the second hydraulic chamber and a second port of the pump, and cooperated with the second hydraulic chamber to construct a second hydraulic pressure transmission path through which the pump pressure is transmitted to a second pressure-receiving surface of the piston facing the second hydraulic chamber, wherein an apparent modulus of volume elasticity of working fluid in the first hydraulic pressure transmission path and an apparent modulus of volume elasticity of working fluid in the second hydraulic pressure transmission path are set to be substantially identical to each other, the apparent modulus of volume elasticity of working fluid in the first hydraulic pressure transmission path corresponding to a ratio of a hydraulic pressure change in the first hydraulic pressure transmission path to a rate of change in working fluid quantity in the first hydraulic pressure transmission path, the working fluid quantity change in the first hydraulic pressure transmission path including a change in volume of the first hydraulic pressure transmission path itself, occurring due to the hydraulic pressure change in the first hydraulic pressure transmission path, and the apparent modulus of volume elasticity of working fluid in the second hydraulic pressure transmission path corresponding to a ratio of a hydraulic pressure change in the second hydraulic pressure transmission path to a rate of change in working fluid quantity in the second hydraulic pressure transmission path, the working fluid quantity change in the second hydraulic pressure transmission path including a change in volume of the second hydraulic pressure transmission path itself, occurring due to the hydraulic pressure change in the second hydraulic pressure transmission path.

The other objects and features of this invention will become understood from the following description with reference to the accompanying drawings.

### BRIEF DESCRIPTION OF THE DRAWINGS

FIG. 1 is a power steering system diagram illustrating an embodiment of a hydraulic power cylinder equipped power steering apparatus.

FIG. 2 is a cross-sectional view illustrating the detailed structure of a first hydraulic line (or a first hydraulic pressure transmission path) constructing a part of a hydraulic circuit of the hydraulic power cylinder equipped power steering apparatus of the embodiment.

FIG. 3 is a characteristic curve illustrating the relationship between the volume ratio of a volume of a low-rigidity line (constructing a part of a hydraulic pressure transmission path) to a total volume of the hydraulic pressure transmission path and an apparent modulus Ke of volume elasticity of working fluid (operating oil).

FIG. 4 is a block diagram illustrating the detailed structure of an electronic control unit incorporated in the power steering system shown in FIG. 1.

FIG. 5 is a block diagram illustrating the detailed structure of a lag-compensation torque calculation section constructing a part of the control unit of FIG. 4.

FIGS. 6A-6B are three different Bode diagrams, each illustrating the frequency response of the hydraulic pressure transmission path, at three different apparent volume moduli Ke.

FIG. 7 shows three different step response characteristics, each corresponding to the hydraulic-pressure step response for the hydraulic pressure transmission path, at three different apparent volume moduli Ke.

FIG. 8 shows two different apparent-volume-modulus Ke versus hydraulic-pressure characteristic curves, with two different hydraulic systems, namely, (A) all steel tubing of a comparative example in the presence of air mixed with working fluid, and (B) the hydraulic pressure transmission path having apparent volume modulus Ke of approximately 200 MPa, in the absence of air mixed with working fluid.

FIG. 9 is a cross-sectional view illustrating the detailed structure of a modified hydraulic pressure transmission path, which is modified from the first hydraulic pressure transmission path shown in FIG. 2.

FIG. 10 is a schematic layout of first and second hydraulic lines, both constructing a part of a hydraulic circuit of the hydraulic power cylinder equipped power steering apparatus of the second embodiment.

FIG. 11 is a schematic layout of modified first and second hydraulic lines, both somewhat modified from the first and second hydraulic lines shown in FIG. 10.

### DESCRIPTION OF THE PREFERRED EMBODIMENTS

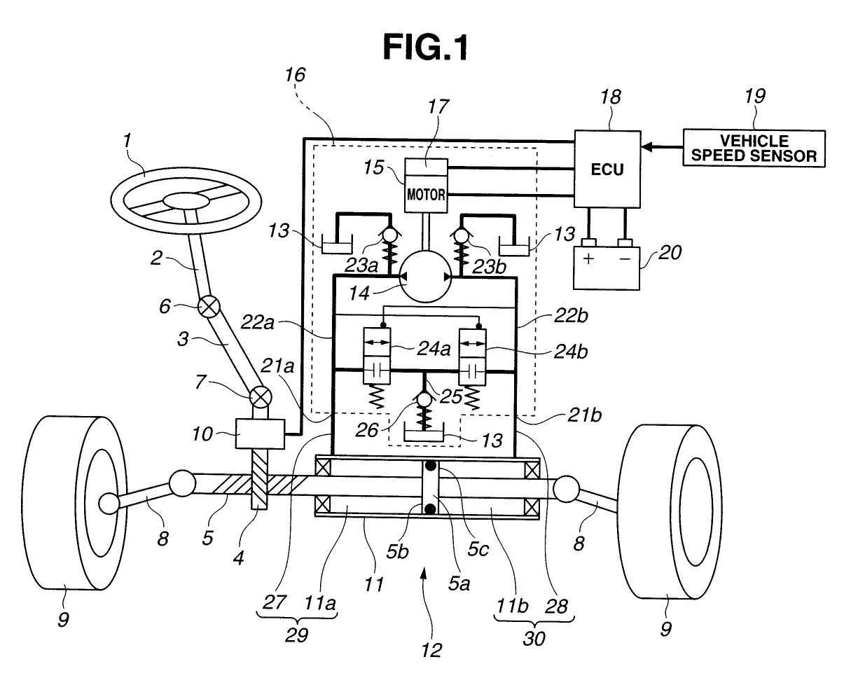

Referring now to the drawings, particularly to FIG. 1, the power steering system of the embodiment is exemplified in an automobile hydraulic power cylinder equipped power steering apparatus, which is configured to enable steering assist force application by operating a hydraulic power cylinder responsively to a steering input (steering torque) transmitted through a steering wheel.

As seen in FIG. 1, a steering wheel 1, which is turned by the driver, is mechanically linked through a steering shaft 2 and an intermediate shaft 3 to a pinion shaft 4. A pinion of pinion shaft 4 is in meshed-engagement with a rack of a rack shaft 5. The pinion of pinion shaft 4 and the rack of rack shaft 5 construct a rack-and-pinion mechanism. The lower end of steering shaft 2 and the upper end of intermediate shaft 3 are mechanically linked to each other via a universal joint 6. The lower end of intermediate shaft 3 and the upper end of pinion shaft 4 are mechanically linked to each other via a universal joint 7. The rack-and-pinion mechanism serves as a rotary-to-linear motion converter that converts rotary motion of steering wheel 1 into linear motion of rack shaft 5. The rack-and-pinion mechanism also constructs a part of a steering mechanism linked to left and right steered road wheels 9, 9. Both ends of rack shaft 5 are mechanically linked via tie rods 8, 8 and steering knuckles (not shown) to the respective steered road wheels 9, 9.

A torque sensor 10 (serving as torque detection means) is installed on or attached to the intermediate portion of pinion shaft 4, for detecting the magnitude and direction of torque acting between steering wheel 1 and each of the steered road wheels, substantially corresponding to the magnitude and direction of steering torque (steering wheel torque) applied to steering wheel 1 about its axis of rotation by the driver. The torque, detected by torque sensor 10, is hereinafter referred to as “steering input torque Ts”.

Rack shaft 5 is installed in a power cylinder tube 11 in such a manner as to extend in the axial direction of power cylinder tube 11. A piston 5a is also located in power cylinder tube 11 and installed substantially at a midpoint of rack shaft 5 so that piston 5a is movable together with rack shaft 5. That is, piston 5a is fixedly connected to rack shaft 5. As can be seen from the system diagram of FIG. 1, an internal space of power cylinder tube 11 is divided into a first hydraulic chamber 11a defined on the left-hand sidewall surface (corresponding to the first pressure-receiving surface 5b described later) of piston 5a (viewing FIG. 1) and a second hydraulic chamber 11b defined on the right-hand sidewall surface (corresponding to the second pressure-receiving surface 5c described later) of piston 5a. That is, rack shaft 5, power cylinder tube 11, and piston 5a construct a steering-assist hydraulic power cylinder 12.

A pump unit 16 is connected to power cylinder 12. Pump unit 16 (serving as a hydraulic pressure source or hydraulic pressure generating means) is mainly comprised of a reservoir tank 13 (serving as working-fluid storage means) for storing working fluid (operating oil), a reversible oil pump 14, and an electric motor 15 for driving the pump. For the purpose of steering assistance, the driving state of pump unit 16 is controlled by means of an electronic control unit or a controller 18 (described later), so as to selectively supply working fluid (hydraulic pressure) to either one of two hydraulic chambers 11a-11b of power cylinder 12 and direct or drain working fluid from the other hydraulic chamber to reservoir tank 13. In the shown embodiment, electric motor 15 is a direct-current three-phase brushless motor, which can rotate in a reverse-rotational direction and in a normal-rotational direction. Motor 15 is operated by means of a three-phase circuit having a U phase, a V phase, and a W phase and energized by voltages that differ in phase by one-third of a cycle. A motor rotational position sensor (or a motor rotation angle sensor) 17 is attached to motor 15 (exactly, a rotor of the brushless motor) for detecting a rotational position (or a rotation angle) of the motor rotor of motor 15, and for generating a signal indicative of the motor rotational position.

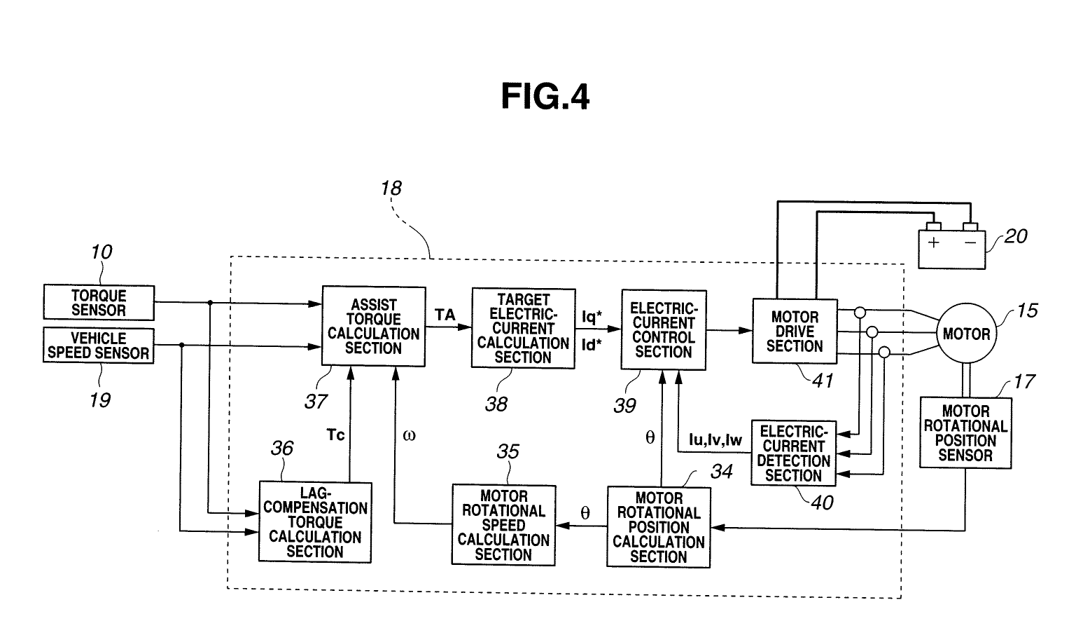

Also provided is control unit (controller) 18 serving as pump driving-state control means. Control unit 18 generally comprises a microcomputer. Control unit 18 includes an input/output interface (I/O), memories (RAM, ROM), and a microprocessor or a central processing unit (CPU). The input/output interface (I/O) of control unit 18 receives input information from various engine/vehicle sensors, concretely, a steering torque Ts signal from torque sensor 10, a motor rotational position θ signal from motor rotational position sensor 17, and a vehicle speed VSP signal from a vehicle speed sensor 19. As described later in reference to the block diagram of FIG. 4, a duty cycle of a pulse-width modulated signal, used for controlling the driving state of motor 15 and obtained by regulating electric power from a battery 20, is determined based on these signals Ts, θ, and VSP.

Reversible oil pump 14 is accommodated in a pump body or a pump housing. Reversible oil pump 14 has two pump inlet-and-outlet ports. Pump unit 16 has two suction-and-discharge ports 21a and 21b, both opening outside of pump 14. A first working fluid line 22a is formed in the pump housing in such a manner as to communicate the first suction-and-discharge port 21a of pump unit 16 with the first pump inlet-and-outlet port of pump 14. In a similar manner, a second working fluid line 22b is formed in the pump housing in such a manner as to communicate the second suction-and-discharge port 21b of pump unit 16 with the second pump inlet-and-outlet port of pump 14.

One end of first fluid line 22a is connected to the first pump inlet-and-outlet port and also connected via a first check valve 23a to reservoir tank 13. In a similar manner, one end of second fluid line 22b is connected to the second pump inlet-and-outlet port and also connected via a second check valve 23b to reservoir tank 13. First check valve 23a is provided to permit only the free flow of working fluid from reservoir tank 13 into first fluid line 22a. Second check valve 23b is provided to permit only the free flow of working fluid from reservoir tank 13 into second fluid line 22b. Thus, when a lack of working fluid in first fluid line 22a and/or second fluid line 22b occurs, working fluid can be supplied from reservoir tank 13 via first check valve 23a and/or second check valve 23b into first fluid line 22a and/or second fluid line 22b.

A drain fluid line 25 is formed or bored in the pump housing. As clearly shown in FIG. 1, first fluid line 22a is connected through a first directional control valve 24a to drain fluid line 25, whereas second fluid line 22b is connected through a second directional control valve 24b to drain fluid line 25. A backpressure valve 26 is disposed in drain fluid line 25. Each of first and second directional control valves 24a-24b is constructed by a normally-closed pilot-actuated two-position directional control valve. First directional control valve 24a is configured to actuate, using the hydraulic pressure of working fluid in second fluid line 22b as an external pilot pressure. On the other hand, second directional control valve 24b is configured to actuate, using the hydraulic pressure of working fluid in first fluid line 22a as an external pilot pressure. That is, backpressure valve 26 is configured to open so as to drain working fluid through first and second directional control valves 24a-24b via drain fluid line 25 to reservoir tank 13, when the hydraulic pressure of working fluid flowing out of first and second hydraulic chambers 11a-11b becomes greater than a predetermined pressure value.

Pump unit 16 and first hydraulic chamber 11a are connected to each other through the use of a first hydraulic line 27 whose one end is connected to first suction-and-discharge port 21a. Pump unit 16 and second hydraulic chamber 11b are connected to each other through the use of a second hydraulic line 28 whose one end is connected to second suction-and-discharge port 21b. In other words, first hydraulic chamber 11a and pump 14 are connected to each other through the use of first hydraulic line 27. First hydraulic line 27 and first hydraulic chamber 11a construct a first hydraulic pressure transmission path 29 through which the hydraulic pressure, produced by pump 14, (simply, the pump pressure) is transmitted to the first pressure-receiving surface 5b of piston 5a facing first hydraulic chamber 11a. On the other hand, second hydraulic chamber 11b and pump 14 are connected to each other through the use of second hydraulic line 28. Second hydraulic line 28 and second hydraulic chamber 11b construct a second hydraulic pressure transmission path 30 through which the pump pressure is transmitted to the second pressure-receiving surface 5c of piston 5a facing second hydraulic chamber 11b.

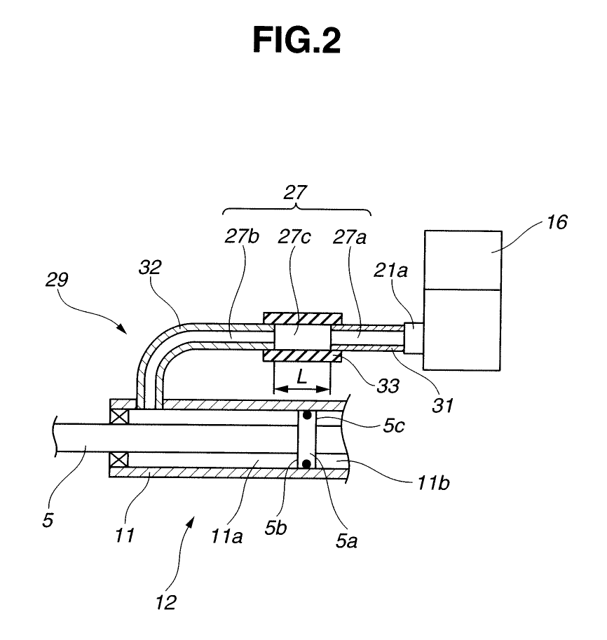

Referring now to FIG. 2, there is shown the detailed structure of first hydraulic line 27, constructing a part of the hydraulic circuit of the power steering apparatus of the embodiment shown in FIG. 1. In the power steering apparatus of the embodiment of FIG. 1, the constructions (the shape and dimensions) are the same in first and second hydraulic lines 27-28. For the sake of simplicity, FIG. 2 shows the detailed structure for only the first hydraulic line 27.

As clearly shown in FIG. 2, first hydraulic line 27 is comprised of a pump-side high-rigidity line 27a, a power-cylinder-side high-rigidity line (simply, a cylinder-side high-rigidity line) 27b, and a low-rigidity line 27c. Pump-side high-rigidity line 27a is formed of a substantially straight steel tube 31 whose one end is connected to first suction-and-discharge port 21a of pump unit 16. Cylinder-side high-rigidity line 27b is formed of a substantially right-angled steel tube 32, which is bent toward the first hydraulic chamber 11a such that one end is connected to first hydraulic chamber 11a. Low-rigidity line 27c is formed of a flexible tube (or an elastically deformable tube) 33, which is made of a synthetic rubber, that is, an elastomeric material (a polymeric material) having a rubber elasticity. Low-rigidity line 27c serves as a variable volume section (a volume increase-and-decrease section or a variable volume hydraulic-line section) through which pump-side high-rigidity line 27a (the other end of steel tube 31) and cylinder-side high-rigidity line 27b (the other end of steel tube 32) are connected to each other. Low-rigidity line 27c has a lower rigidity, as compared to both of pump-side high-rigidity line 27a and cylinder-side high-rigidity line 27b. That is, low-rigidity line 27c is configured to expand (increase) or contract (decrease) responsively to or depending on a change in the hydraulic pressure in first hydraulic pressure transmission path 29. By the use of low-rigidity line 27c, whose volumetric capacity is elastically varied responsively to a hydraulic pressure change in first hydraulic pressure transmission path 29, and which is disposed in first hydraulic line 27, the total rigidity of first hydraulic pressure transmission path 29 (including first hydraulic line 27) can be reduced.

In the power steering apparatus of the embodiment shown in FIG. 1, notice that the line length L of low-rigidity line 27c is set or designed, fully taking account of the ratio of a hydraulic pressure change in first hydraulic pressure transmission path 29 to a rate of change in working fluid quantity in first hydraulic pressure transmission path 29. As a matter of course, the working fluid quantity change in first hydraulic pressure transmission path 29 includes an increase/decrease in volume of first hydraulic pressure transmission path 29 itself, occurring due to the hydraulic pressure change in first hydraulic pressure transmission path 29. The previously-discussed ratio of the hydraulic pressure change in first hydraulic pressure transmission path 29 to a rate of change in working fluid quantity in first hydraulic pressure transmission path 29 corresponds to an apparent modulus Ke of volume elasticity of working fluid (operating oil) in first hydraulic pressure transmission path 29. As hereunder described in detail, in the power steering apparatus of the embodiment shown in FIG. 1, apparent volume modulus Ke is set to be greater than or equal to 100 MPa and less than or equal to 300 MPa.

More concretely, assuming that a change in hydraulic pressure in first hydraulic pressure transmission path 29 is denoted by “ΔP”, the quantity of working fluid in first hydraulic pressure transmission path 29 before hydraulic pressure change ΔP occurs is denoted by “V”, and a change in working fluid quantity in first hydraulic pressure transmission path 29, occurring due to hydraulic pressure change ΔP, is denoted by “ΔV”, apparent volume modulus Ke of working fluid (operating oil) in first hydraulic pressure transmission path 29 is calculated by the following expression (1), under a specific condition where piston 5a is held at its neutral position corresponding to zero average steer angle of a pair of steered road wheels 9, 9, in the absence of air mixed with working fluid (operating oil).

Ke=ΔP/(ΔV/V)=ΔP×V/ΔV (1)

The specific condition is a prerequisite for calculating apparent volume modulus Ke by using the above-mentioned expression (1).

The previously-noted quantity V of working fluid in first hydraulic pressure transmission path 29 before the occurrence of hydraulic pressure change ΔP is calculated by the following expression (2).

V=Va+Vb+Vc+Vd (2)

where “Va” denotes a quantity of working fluid in pump-side high-rigidity line 27a before the occurrence of hydraulic pressure change ΔP, “Vb” denotes a quantity of working fluid in cylinder-side high-rigidity line 27b before the occurrence of hydraulic pressure change ΔP, “vc” denotes a quantity of working fluid in low-rigidity line 27c before the occurrence of hydraulic pressure change ΔP, and “Vd” denotes a quantity of working fluid in first hydraulic chamber 11a before the occurrence of hydraulic pressure change ΔP.

The previously-noted change ΔV in working fluid quantity in first hydraulic pressure transmission path 29, occurring due to hydraulic pressure change ΔP, is calculated by the following expression (3).

ΔV=ΔVa+ΔVb+ΔVc+ΔVd (3)

where “ΔVa” denotes a change in working fluid quantity in pump-side high-rigidity line 27a owing to hydraulic pressure change ΔP, “ΔVb” denotes a change in working fluid quantity in cylinder-side high-rigidity line 27b owing to hydraulic pressure change ΔP, “ΔVc” denotes a change in working fluid quantity in low-rigidity line 27c owing to hydraulic pressure change ΔP, and “ΔVd” denotes a change in working fluid quantity in first hydraulic chamber 11a owing to hydraulic pressure change ΔP.

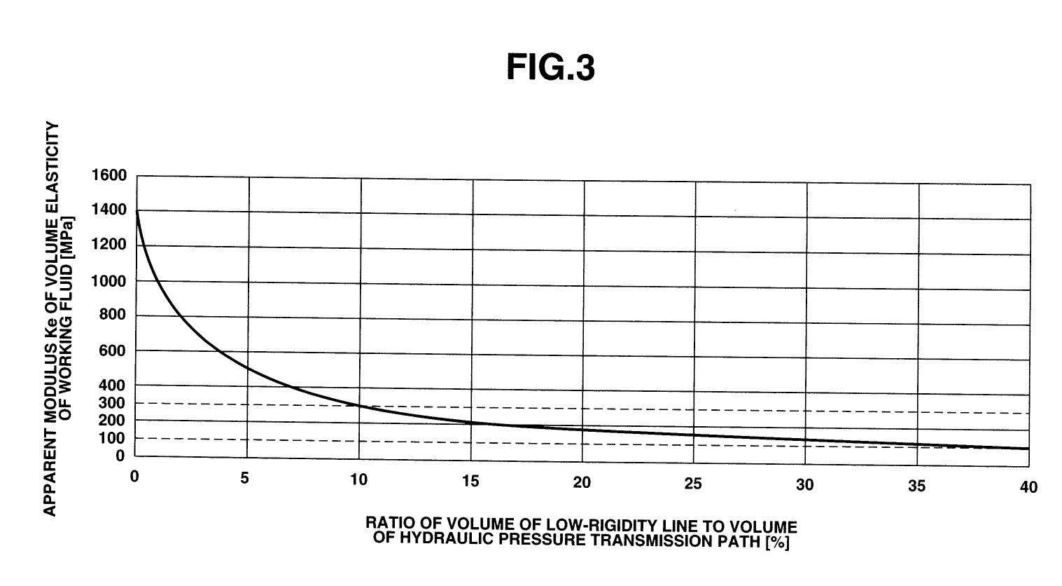

Referring now to FIG. 3, there is shown the characteristic curve illustrating the relationship between the volume ratio of the volume of low-rigidity line 27c to the total volume of first hydraulic pressure transmission path 29 and apparent volume modulus Ke of working fluid (operating oil) in first hydraulic pressure transmission path 29, in the absence of air mixed with working fluid (operating oil).

As can be seen from the characteristic curve of FIG. 3, apparent volume modulus Ke tends to reduce, as the volume ratio of the volume of low-rigidity line 27c to the total volume of first hydraulic pressure transmission path 29 increases. When the volume ratio of the volume of low-rigidity line 27c to the total volume of first hydraulic pressure transmission path 29 is 10%, apparent volume modulus Ke becomes 300 MPa. When the volume ratio of the volume of low-rigidity line 27c to the total volume of first hydraulic pressure transmission path 29 is 40%, apparent volume modulus Ke becomes 100 MPa. Therefore, the line length L of low-rigidity line 27c must be set or designed in such a manner as to satisfy a specified apparent volume modulus range, defined by an inequality 100 MPa≦Ke≦300 MPa, in other words, in such a manner as to satisfy a specified volume ratio of low-rigidity line 27c to first hydraulic pressure transmission path 29, ranging from 10% to 40%. As appreciated from the characteristic curve of FIG. 3, in the power steering apparatus of the embodiment shown in FIG. 1, when the line length L of low-rigidity line 27c is 200 millimeters, the volume ratio of the volume of low-rigidity line 27c to the total volume of first hydraulic pressure transmission path 29 becomes 10%. When the line length L of low-rigidity line 27c is 600 millimeters, the volume ratio of the volume of low-rigidity line 27c to the total volume of first hydraulic pressure transmission path 29 becomes 40%. For the reasons discussed above, first hydraulic line 27 is configured so that the line length L of low-rigidity line 27c is dimensioned to be longer than or equal to 200 millimeters and dimensioned to be shorter than or equal to 600 millimeters, that is, 200 mm≦L≦600 mm. In the embodiment shown in FIG. 1, the constructions (the shape and dimensions) are the same in first and second hydraulic lines 27-28, and thus in order to satisfy a specified apparent volume modulus range, defined by an inequality 100 MPa≦Ke≦300 MPa, second hydraulic line 28 is also configured so that the line length L of its low-rigidity line is dimensioned to be longer than or equal to 200 millimeters and dimensioned to be shorter than or equal to 600 millimeters, that is to say, 200 mm≦L≦600 mm.

Referring now to FIG. 4, there is shown the block diagram of control unit 18. The detailed structure of control unit 18 is hereinafter explained in reference to the block diagram of FIG. 4.

A motor rotational position calculation section (motor rotational position calculation means) 34 is configured to calculate, based on a sensor signal from motor rotational position sensor 17, motor rotational position θ as an electrical angle.

A motor rotational speed calculation section (motor rotational speed calculation means) 35 is configured to calculate, based on a rate of change in motor rotational position θ, a motor rotational speed ω (=dθ/dt).

Also provided is a lag-compensation torque calculation section 36, which serves as lag-compensation torque calculation means configured to phase-lead a phase of steering-input-torque Ts signal from torque sensor 10 by a predetermined phase angle, so as to correct or compensate for a response lag of the steering-assist control system to steering input, which response lag occurs owing to expansion of each of first and second hydraulic lines 27-28 and also owing to air undesirably mixed with working fluid (operating oil). Concretely, lag-compensation torque calculation section 36 is configured to calculate, based on steering-input-torque Ts signal from torque sensor 10 and vehicle-speed VSP signal from vehicle speed sensor 19, a lag-compensation torque Tc.

An assist torque calculation section (assist torque calculation means) 37 is configured to calculate an assist driving torque TA, based on motor rotational speed ω (=dθ/dt) and lag-compensation torque Tc, as well as steering-input-torque Ts signal from torque sensor 10 and vehicle-speed VSP signal from vehicle speed sensor 19. Target electric currents Iq* and Id* (both described later) are calculated or determined based on assist driving torque TA, calculated by assist torque calculation section 37. More concretely, assist torque calculation section 37 calculates, first of all, a basic assist driving torque based on steering-input-torque Ts signal from torque sensor 10 and vehicle-speed VSP signal from vehicle speed sensor 19. Next, assist driving torque TA is calculated by adding and subtracting the calculated lag-compensation torque Tc and/or a motor-rotational-speed dependent correction torque value determined based on motor rotational speed ω (=dθ/dt) to and from the calculated basic assist driving torque, if necessary.

A target electric-current calculation section (target electric-current calculation means) 38 is configured to calculate, based on the calculated value of assist driving torque TA, target electric current Iq* of a q-axis and target electric current Id* of a d-axis.

An electric-current control section (electric current control means) 39 is configured to calculate, based on motor rotational position θ, an actual electric current Iq of the q-axis and an actual electric current Id of the d-axis, by 3-phase-to-2-phase conversion of actual electric currents Iu, Iv, and Iw of the U, V, and W phases. Actual electric currents Iu, Iv, and Iw of the U, V, and W phases are detected by an electric-current detection section (electric-current detection means) 40. A duty cycle of a pulse-width modulated (PWM) signal, used for controlling the driving state of motor 15 by feedback control (closed-loop control), e.g., proportional-plus-integral-plus-derivative (PID) control, is determined based on a deviation between actual electric current Iq and target electric current Iq* and a deviation between actual electric current Id and target electric current Id*.

A motor drive circuit (motor drive means) 41 includes a power element, such as a field-effect transistor (FET). The electric current, corresponding to target electric currents Iq* and Id*, can be supplied from battery 20 to electric motor 15, by switching the power element (e.g., the FET) in accordance with the duty cycle of the PWM signal, determined by electric-current control section 39.

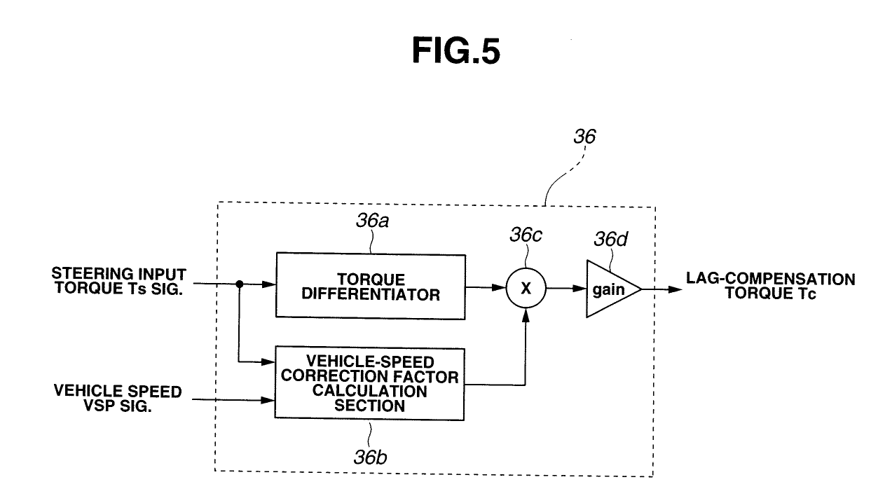

Referring to FIG. 5, there is shown the block diagram of lag-compensation torque calculation section 36. The detailed structure of lag-compensation torque calculation section 36 is hereinafter explained in reference to the block diagram of FIG. 5.

As can be seen from the block diagram of FIG. 5, lag-compensation torque calculation section 36 is comprised of a torque differentiator (torque differentiating means) 36a, a vehicle-speed correction factor calculation section (vehicle-speed correction factor calculation means) 36b arranged in parallel with torque differentiator 36a, a multiplier 36c connected to both torque differentiator 36a and vehicle-speed correction factor calculation section 36b, and a gain amplifier 36d connected to multiplier 36c.

Torque differentiator 36a is provided to phase-lead the phase of steering-input-torque Ts signal from torque sensor 10. In the shown embodiment, torque differentiator 36a is constructed by a high-pass filter. More concretely, torque differentiator 36a is configured to calculate a torque differentiation value by differentiating steering-input-torque Ts signal from torque sensor 10.

Vehicle-speed correction factor calculation section 36b is configured to calculate, based on steering-input-torque Ts signal from torque sensor 10 and vehicle-speed VSP signal from vehicle speed sensor 19, a vehicle-speed dependent correction factor, while retrieving a preprogrammed vehicle-speed dependent correction factor map showing how the vehicle-speed dependent correction factor must be varied with respect to steering input torque Ts and vehicle speed VSP.

Multiplier 36c is configured to calculate a basic lag-compensation torque by multiplying the torque differentiation value calculated by torque differentiator 36a with the vehicle-speed dependent correction factor calculated by vehicle-speed correction factor calculation section 36b.

Thereafter, lag-compensation torque Tc is calculated by multiplying the basic lag-compensation torque calculated by multiplier 36c with a gain coefficient of gain amplifier 36d. The gain coefficient of gain amplifier 36d is variably set depending on apparent volume modulus Ke.

Therefore, in the power steering apparatus of the embodiment shown in FIG. 1, when steering wheel 1 is turned to the right (i.e., in the clockwise direction) and thus control unit 18 drives electric motor 1 responsively to steering input torque Ts detected by torque sensor 10, the pump pressure, produced by pump 14, is transmitted through first hydraulic pressure transmission path 29 to first pressure-receiving surface 5b of piston 5a. As a result, power cylinder 12 can produce a steering assist force for rightward steering assistance. When the pump pressure is transmitted through first hydraulic pressure transmission path 29 to first pressure-receiving surface 5b, a response lag of the steering-assist control system to steering input tends to occur owing to expansion of low-rigidity line 27c of first hydraulic pressure transmission line 29 and also owing to compression of air mixed with working fluid (operating oil). However, according to the power steering apparatus of the embodiment shown in FIG. 1, such a response lag can be corrected by means of lag-compensation torque calculation section 36 of control unit 18, during a right-hand turn.

In a similar manner, when steering wheel 1 is turned to the left (i.e., in the counterclockwise direction) and thus control unit 18 drives electric motor 1 responsively to steering input torque Ts detected by torque sensor 10, the pump pressure from pump 14 is transmitted through second hydraulic pressure transmission path 30 to second pressure-receiving surface 5c of piston 5a. As a result, power cylinder 12 can produce a steering assist force for leftward steering assistance. When the pump pressure is transmitted through second hydraulic pressure transmission path 30 to second pressure-receiving surface 5c, a response lag of the steering-assist control system to steering input tends to occur owing to expansion of the low-rigidity line of second hydraulic pressure transmission line 30 and also owing to compression of air mixed with working fluid (operating oil). However, according to the power steering apparatus of the embodiment shown in FIG. 1, such a response lag can be corrected by means of lag-compensation torque calculation section 36 of control unit 18, during a left-hand turn.

Hitherto, the rigidities of the first and second hydraulic lines, associated with respective hydraulic chambers of the power cylinder, were not taken into account at all. For instance, when the first and second hydraulic lines have excessively low rigidities, the steering responsiveness to high-frequency steering input tends to deteriorate. Thus, with the first and second hydraulic lines having excessively low rigidities, in the presence of a rapid steering input, there is a risk of insufficient steering action, in other words, inadequate steering responsiveness. Conversely when the first and second hydraulic lines have excessively high rigidities, during steering input (i.e., during rotary motion of the steering wheel), there is a risk of a hydraulic pressure surge (e.g., an unstable hydraulic pressure buildup) in working fluid in the hydraulic pressure transmission path (at least one of the first and second hydraulic pressure transmission paths, associated with respective hydraulic chambers of the power cylinder). Undesirable vibrations, resulting from such a hydraulic pressure surge, tend to be transmitted to the steering wheel, thus deteriorating a steering feel.

Furthermore, in the presence of air mixed with working fluid (operating oil), due to the compressibility of the mixed air, apparent modulus Ke of volume elasticity of working fluid tends to be affected by hydraulic pressure changes in the first and second hydraulic pressure transmission paths. In the case of the first and second hydraulic lines having high rigidities, apparent volume modulus Ke is remarkably affected by hydraulic pressure changes in the first and second hydraulic pressure transmission paths. When the hydraulic pressure in the first and second hydraulic pressure transmission paths is low, the response lag of the steering-assist control system to steering input tends to become great, thereby resulting in a lack in steering assistance torque, in other words, a lag of steering output. Conversely when the hydraulic pressure in the first and second hydraulic pressure transmission paths is high, the response lag of the steering-assist control system to steering input tends to become less, and therefore there is a possibility of excessive steering assistance torque, in other words, a hydraulic pressure surge in the first and second hydraulic pressure transmission paths. In such a case, as previously discussed, undesirable vibrations, resulting from the hydraulic pressure surge, tend to be transmitted to the steering wheel, thus deteriorating a steering feel.

In contrast to the above, according to the power steering apparatus of the embodiment shown in FIG. 1, low-rigidity line 27c is disposed in first hydraulic line 27, whereas the low-rigidity line having the same construction as low-rigidity line 27c of first hydraulic line 27 is also disposed in second hydraulic line 28. Additionally, the line length L of the low-rigidity line and the volume ratio of the volume of the low-rigidity line to the total volume of the hydraulic pressure transmission line (each of first and second hydraulic pressure transmission lines 29-30) are set to specified values, in order to satisfy apparent volume modulus Ke, ranging from 100 MPa to 300 MPa, that is, 100 MPa≦Ke≦300 MPa. The proper settings of the low-rigidity line length L and the volume ratio of the low-rigidity line to the hydraulic pressure transmission line, insure the enhanced steering feel.

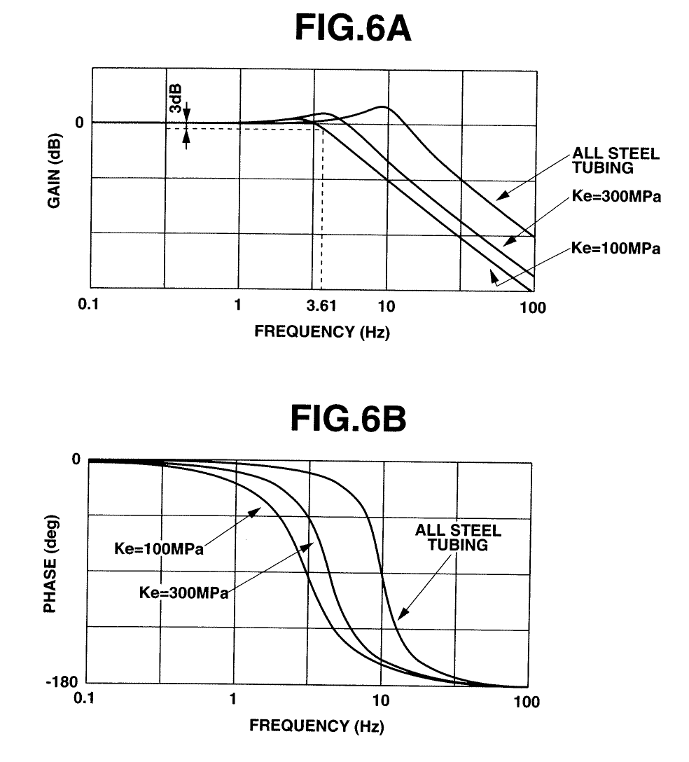

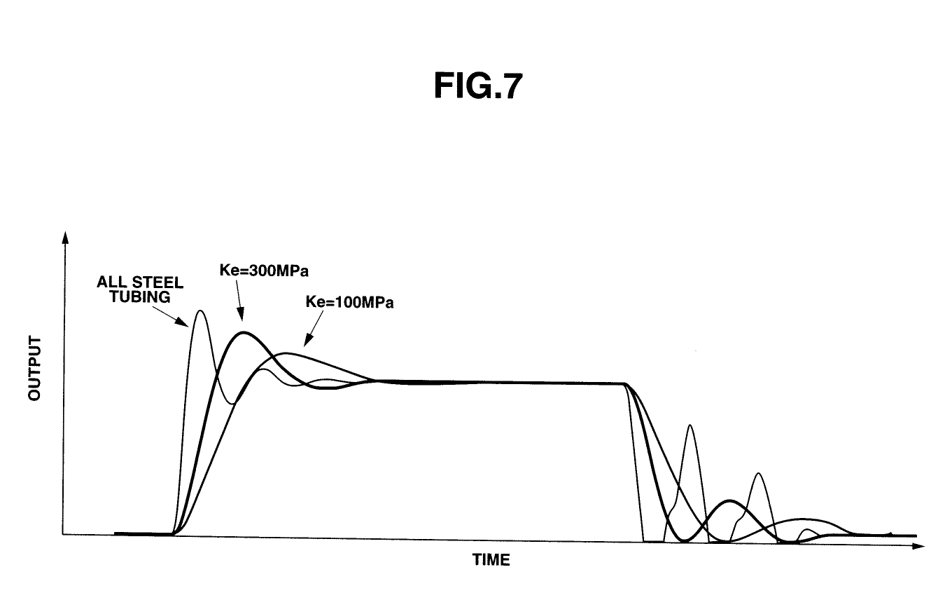

FIGS. 6A-6B show three different Bode diagrams, each illustrating the frequency response of the hydraulic pressure transmission path (each of first and second hydraulic pressure transmission paths 29-30), at three different apparent volume moduli Ke, namely, Ke=100 MPa, Ke=300 MPa, and all steel tubing having a considerably high rigidity >>300 MPa. On the other hand, FIG. 7 shows three different step response characteristics, each corresponding to the hydraulic-pressure step response for the hydraulic pressure transmission path (each of first and second hydraulic pressure transmission paths 29-30), at three different apparent volume moduli Ke, namely, Ke=100 MPa, Ke=300 MPa, and all steel tubing having the considerably high rigidity >>300 MPa.

The fundamental reasons for setting apparent volume modulus Ke (of working fluid in each of first and second hydraulic pressure transmission paths 29-30) within a specified apparent volume modulus range, defined by an inequality 100 MPa≦Ke≦300 MPa, are hereunder described in detail in reference to the Bode diagrams of FIGS. 6A-6B and the step response characteristics of FIG. 7.

As can be seen from the three different Bode diagrams of FIGS. 6A-6B, in particular, the three different gain versus frequency ωc curves shown in FIG. 6A, the closed-loop response frequency ωc, at which the gain becomes −3 dB, tends to reduce, as apparent volume modulus Ke reduces. Notice that the bandwidth of the closed-loop steering-assist control system is measured at the −3 dB frequency on the Bode diagram. Concretely, in the case of Ke=100 MPa, the frequency ωc of response of the closed-loop control system becomes 3.61 Hz, at −3 dB frequency on the Bode diagram. When apparent volume modulus Ke of working fluid becomes less than 100 MPa, the response frequency ωc also becomes less than 3.61 Hz. The steering frequency of the steering system, needed to avoid a critical condition of the vehicle, tends to become 3.61 Hz (i.e., at the maximum steering frequency). Therefore, in order to set the response frequency ωc of each of first and second hydraulic pressure transmission paths 29-30 to a value greater than or equal to 3.61 Hz, apparent volume modulus Ke (of working fluid in each of first and second hydraulic pressure transmission paths 29-30) is set to a value greater than or equal to 100 MPa, that is, Ke≧100 MPa.

As can be seen from hydraulic-pressure step response characteristics (transient response characteristics) for the hydraulic pressure transmission path (each of first and second hydraulic pressure transmission paths 29-30) at three different apparent volume moduli, shown in FIG. 7, the time constant of the response to a step input tends to decrease, as the apparent volume modulus Ke increases. However, vibrations (undesirable overshoots and undershoots) of the output at the leading edge and at the trailing edge tend to increase, as the apparent volume modulus Ke increases Concretely, in the case of Ke=300 MPa, the vibration level, which indicates the magnitude of the vibration of the output at the leading edge and at the trailing edge, becomes 6 dB, substantially corresponding to a permissible limit. Notice that the driver's minimum sensible vibration level is 3 dB. Fully taking account of a double margin (3 dB×2=6 dB) taken as a margin of safety, in order to suppress the vibration level to 6 dB or less, apparent volume modulus Ke (of working fluid in each of first and second hydraulic pressure transmission paths 29-30) is set to a value less than or equal to 300 MPa, that is, Ke≦300 MPa.

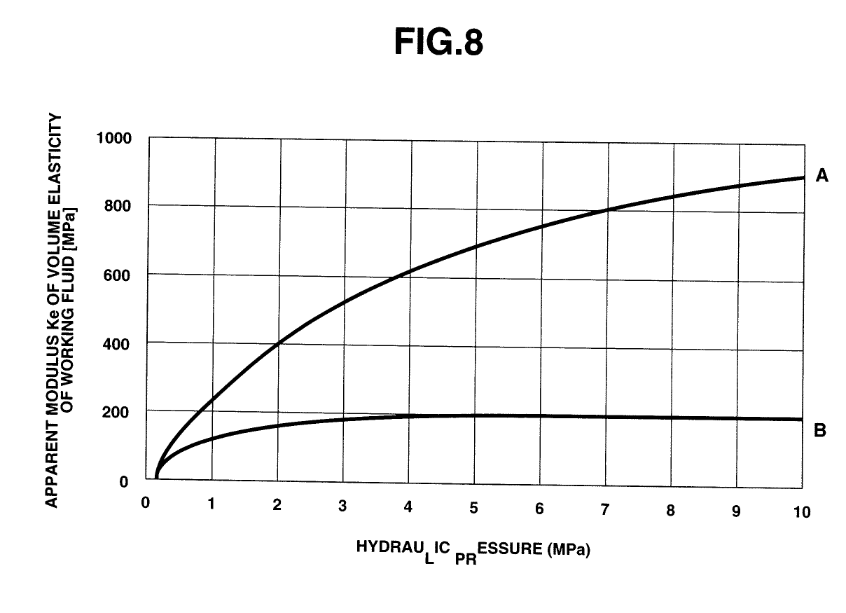

Referring to FIG. 8, there are shown two different apparent-volume-modulus Ke versus hydraulic-pressure characteristic curves, with two different hydraulic systems, namely, (A) all steel tubing of the comparative example having a considerably high rigidity >>300 MPa, in the presence of air mixed with working fluid, and (B) the hydraulic pressure transmission path (each of first and second hydraulic pressure transmission paths 29-30) having apparent volume modulus Ke of approximately 200 MPa, that is, Ke≈200 MPa, in the absence of air mixed with working fluid. The upper characteristic curve “A” shown in FIG. 8 indicates the relationship between apparent volume modulus Ke of working fluid in the all steel tubing of the comparative example and the hydraulic pressure in the all steel tubing of the comparative example, in the presence of air mixed with working fluid. On the other hand, the lower characteristic curve “B” shown in FIG. 8 indicates the relationship between apparent volume modulus Ke of working fluid in the hydraulic pressure transmission path (each of first and second hydraulic pressure transmission paths 29-30) of the embodiment and the hydraulic pressure in the hydraulic pressure transmission path of the embodiment, in the absence of air mixed with working fluid.

As can be seen from the upper apparent-volume-modulus Ke versus hydraulic-pressure characteristic curve A of the comparative example having an excessively high rigidity, in other words, an excessively high apparent volume modulus Ke greater than 800 MPa, in the presence of air mixed with working fluid, a rate of change in apparent volume modulus Ke of working fluid with respect to a change in hydraulic pressure in the hydraulic pressure transmission path (all steel tubing) is comparatively great. In contrast, as can be seen from the lower apparent-volume-modulus Ke versus hydraulic-pressure characteristic curve B of the embodiment having a suitably tuned rigidity (simply, a suitable rigidity), that is, a suitable apparent volume modulus Ke of approximately 200 MPa, which is within the specified apparent volume modulus range of 100 MPa≦Ke≦300 MPa by virtue of the provision of low-rigidity line 27c, the rigidity of the hydraulic pressure transmission path (partially containing the low-rigidity line) is set to be lower than that of the hydraulic pressure transmission path (all steel tubing) of the comparative example. Thus, in the case of the lower characteristic curve B of the embodiment, a rate of change in apparent volume modulus Ke of working fluid with respect to a change in hydraulic pressure in the hydraulic pressure transmission path (partially containing the low-rigidity line) is comparatively small. Therefore, by means of lag-compensation torque calculation section 36, it is possible to effectively compensate for a response lag of the control system to steering input.

As set forth above, according to the power steering apparatus of the embodiment, volume increase-and-decrease sections (i.e., low-rigidity lines), whose volumetric capacities are elastically varied responsively to hydraulic pressure changes in first and second hydraulic pressure transmission paths, are disposed in the respective hydraulic pressure transmission paths. Additionally, the ratio of a hydraulic pressure change in the hydraulic pressure transmission path (each of first and second hydraulic pressure transmission paths 29-30) to a rate of change in working fluid quantity in the hydraulic pressure transmission path, the working fluid quantity change in the hydraulic pressure transmission path including an increase/decrease in a volume of the hydraulic pressure transmission path, occurring due to the hydraulic pressure change in the hydraulic pressure transmission path, that is to say, an apparent modulus Ke of volume elasticity of working fluid (operating oil) in the hydraulic pressure transmission path, is set to a value greater than or equal to 100 MPa, i.e., Ke≧100 MPa. Therefore, it is possible to ensure a suitable steering responsiveness to high-frequency steering input, thereby enhancing or improving a steering feel. Furthermore, through the use of the hydraulic pressure transmission path partially containing the low-rigidity line, it is possible to reduce a rate of change in apparent volume modulus Ke of working fluid in the hydraulic pressure transmission path (each of first and second hydraulic pressure transmission paths 29-30) with respect to a change in hydraulic pressure in the hydraulic pressure transmission path. Therefore, it is possible to effectively compensate for a system response lag to steering input by means of a phase-lag compensator (i.e., lag-compensation torque calculation section 36). Setting of the volume ratio of the volume of the low-rigidity line to the total volume of the hydraulic pressure transmission path (each of first and second hydraulic pressure transmission paths 29-30) to a value 40% or less, is equivalent to the suitable setting of apparent volume modulus Ke of working fluid (operating oil) in the hydraulic pressure transmission path to 100 MPa or more, that is, Ke≧100 MPa (see FIG. 3). Accordingly, by setting of the volume ratio of the volume of the low-rigidity line to the total volume of the hydraulic pressure transmission path (each of first and second hydraulic pressure transmission paths 29-30) to a value 40% or less, it is possible to provide the same operation and effects as the suitable setting of apparent volume modulus Ke, that is, Ke≧100 MPa.

In the shown embodiment, moreover, apparent volume modulus Ke of working fluid (operating oil) in the hydraulic pressure transmission path, is set to a value less than or equal to 300 MPa, i.e., Ke≦300 MPa. Therefore, it is possible to suppress or prevent a hydraulic pressure surge from occurring in the hydraulic pressure transmission path (each of first and second hydraulic pressure transmission paths 29-30), thereby enhancing or improving a steering feel. Setting of the volume ratio of the volume of the low-rigidity line to the total volume of the hydraulic pressure transmission path (each of first and second hydraulic pressure transmission paths 29-30) to a value 10% or more, is equivalent to the suitable setting of apparent volume modulus Ke of working fluid (operating oil) in the hydraulic pressure transmission path to 300 MPa or less, that is, Ke≦300 MPa (see FIG. 3). Accordingly, by setting of the volume ratio of the volume of the low-rigidity line to the total volume of the hydraulic pressure transmission path (each of first and second hydraulic pressure transmission paths 29-30) to a value 10% or more, it is possible to provide the same operation and effects as the suitable setting of apparent volume modulus Ke, that is, Ke≦300 MPa.

Additionally, according to the power steering apparatus of the embodiment, each of first and second hydraulic lines is comprised of steel tubes (tubes 31-32), and a flexible tube (tube 33) serving as a volume increase-and-decrease section (low-rigidity line 27c) and made of a synthetic rubber (i.e., an elastomeric material or a polymeric material) having a rubber elasticity. Therefore, the power steering apparatus of the embodiment has an additional merit, that is, the ease of adjusting apparent volume modulus Ke of working fluid (operating oil) in the hydraulic pressure transmission path.

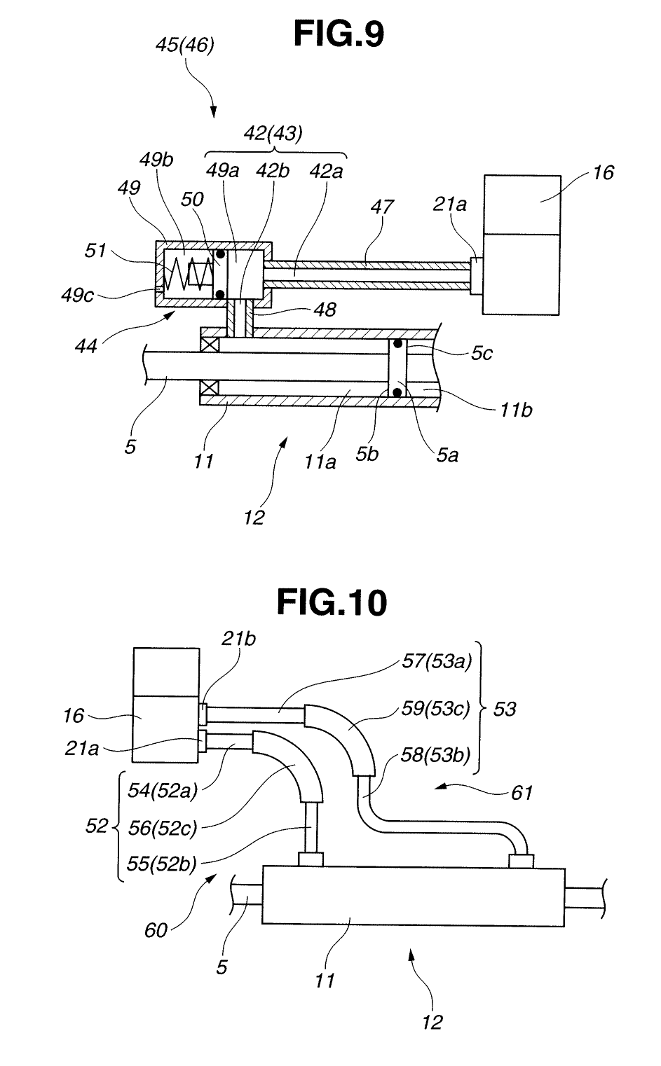

Referring to FIG. 9, there is shown the detailed structure of the modified hydraulic pressure transmission path, which is modified from the first hydraulic pressure transmission path shown in FIG. 2. As previously described, in the power steering apparatus of the embodiment shown in FIGS. 1-2, the low-rigidity line (i.e., the volume increase-and-decrease section or the variable volume section), which is formed of flexible tube 33, is disposed in each of first and second hydraulic lines 27-28. On the other hand, in the modification shown in FIG. 9, a hydraulic accumulator 44 is interleaved or disposed in each of first and second hydraulic lines 42-43. In the modification of FIG. 9, the constructions (the shape and dimensions) are the same in first and second hydraulic pressure transmission paths 45-46. For the sake of simplicity, FIG. 9 shows the detailed structure for only the first hydraulic pressure transmission path 45.

As clearly shown in FIG. 9, accumulator 44 is comprised of a cylinder 49, a piston 50, and a coil spring 51. Piston 50 is a cylindrical member machined to slide in a very-close fitting bore (a cylindrical-hollow internal space) defined in cylinder 49. The internal space of cylinder 49 is divided into a hydraulic chamber (a variable volume chamber) 49a and a spring chamber 49b by the slidable piston 50. As seen from the cross section of FIG. 9, piston 50 is preloaded or permanently forced toward hydraulic chamber 49a with spring 51, which is operably accommodated in spring chamber 49b. A small air bleed hole 49c is bored in the bottom wall of the spring-chamber side of cylinder 49.

In the modification of FIG. 9, first hydraulic line 42 is comprised of a pump-side high-rigidity line 42a, a power-cylinder-side high-rigidity line (simply, a cylinder-side high-rigidity line) 42b, and hydraulic chamber 49a of accumulator 44. Pump-side high-rigidity line 42a is formed of a substantially straight steel tube 47 whose one end is connected to first suction-and-discharge port 21a of pump unit 16. Cylinder-side high-rigidity line 42b is formed of a substantially straight steel tube 48 whose one end is connected to first hydraulic chamber 11a. The other end of steel tube 47 and the other end of steel tube 48 are connected to respective fluid ports of the hydraulic chamber side of accumulator 44. That is, hydraulic chamber 49a of accumulator 44 constructs a part of the hydraulic line (each of first and second hydraulic lines 42-43). Additionally, hydraulic chamber 49a of accumulator 44 serves as a variable volume section (a volume increase-and-decrease section or a variable volume hydraulic-line section) whose volumetric capacity can be elastically varied responsively to a hydraulic pressure change in the hydraulic pressure transmission path (each of first and second hydraulic pressure transmission paths 45-46). In the modified hydraulic pressure transmission path of FIG. 9, utilizing the spring-loaded accumulator 44, spring 51 is the source of energy that acts against piston 50, forcing the working fluid into the hydraulic system (power cylinder 12). The pressure generated by the spring-loaded accumulator 44 depends on preloading of spring 51, that is, a spring stiffness of spring 51. For the reasons discussed above, in the case of the modification of FIG. 9, the spring stiffness of spring 51 is designed or set in a manner so as to satisfy apparent volume modulus Ke, ranging from 100 MPa to 300 MPa, that is, 100 MPa≦Ke≦300 MPa. Therefore, the modification of FIG. 9 can provide the same operation and effects as the power steering apparatus of the embodiment shown in FIGS. 1-2.

Referring to FIG. 10, there is shown the schematic layout of first and second hydraulic pressure transmission paths 60-61 (in particular, first and second hydraulic lines 52-53), constructing the hydraulic circuit of the hydraulic power cylinder equipped power steering apparatus of the second embodiment. The hydraulic circuit of the second embodiment of FIG. 10 is similar to the first embodiment of FIG. 2, except that, in the second embodiment, the shapes and dimensions (in particular, line lengths) of first and second hydraulic lines 52-53 differ from each other. Thus, the same reference signs used to designate elements in the first embodiment shown in FIG. 2 will be applied to the corresponding elements used in the second embodiment shown in FIG. 10, for the purpose of comparison of the first and second embodiments.

As seen from the schematic layout of FIG. 10, in the second embodiment, the line length of first hydraulic line 52 is different from that of second hydraulic line 53.

The comparatively short, first hydraulic line 52 is comprised of a pump-side first high-rigidity line 52a, a power-cylinder-side first high-rigidity line (simply, a cylinder-side first high-rigidity line) 52b, and a first low-rigidity line 52c. Pump-side first high-rigidity line 52a is formed of a substantially straight steel tube 54 whose one end is connected to first suction-and-discharge port 21a of pump unit 16. Cylinder-side first high-rigidity line 52b is formed of a substantially straight steel tube 55 whose one end is connected to first hydraulic chamber 11a of power cylinder 12. First low-rigidity line 52c is formed of a substantially right-angled flexible tube (or an elastically deformable bent tube) 56, which is made of a synthetic rubber, that is, an elastomeric material (a polymeric material) having a rubber elasticity. First low-rigidity line 52c serves as a variable volume section (a volume increase-and-decrease section or a variable volume hydraulic-line section) through which pump-side first high-rigidity line 52a (the other end of steel tube 54) and cylinder-side first high-rigidity line 52b (the other end of steel tube 55) are connected to each other.

On the other hand, the comparatively long, second hydraulic line 53 is comprised of a pump-side second high-rigidity line 53a, a power-cylinder-side second high-rigidity line (simply, a cylinder-side second high-rigidity line) 53b, and a second low-rigidity line 53c. Pump-side second high-rigidity line 53a is formed of a substantially straight steel tube 57 whose one end is connected to second suction-and-discharge port 21b of pump unit 16. Cylinder-side second high-rigidity line 53b is formed of a substantially crank-shaped steel tube 58 whose one end is connected to second hydraulic chamber 11b of power cylinder 12. Second low-rigidity line 53c is formed of a substantially right-angled flexible tube (or an elastically deformable bent tube) 59, which is made of a synthetic rubber, that is, an elastomeric material (a polymeric material) having a rubber elasticity. Second low-rigidity line 53c serves as a variable volume section (a volume increase-and-decrease section or a variable volume hydraulic-line section) through which pump-side second high-rigidity line 53a (the other end of steel tube 57) and cylinder-side second high-rigidity line 53b (the other end of steel tube 58) are connected to each other. In other words, each of first and second hydraulic lines 52-53 is comprised of a plurality of lines (52a, 52c, 52b; 53a, 53c, 53b) having rigidities differing from each other.

As can be seen in FIG. 10, the material, shape and dimensions, that is, the material, cross-sectional form and line length are the same in first and second low-rigidity lines 52c-53c, such that apparent modulus Ke of volume elasticity of working fluid (operating oil) in first hydraulic pressure transmission path 60 is substantially identical to apparent modulus Ke of volume elasticity of working fluid in second hydraulic pressure transmission path 61. In other words, the volume of first low-rigidity line 52c, associated with the first hydraulic chamber side, and the volume of second low-rigidity line 53c, associated with the second hydraulic chamber side, are set to be substantially identical to each other. That is to say, in the case of the power steering apparatus of the second embodiment of FIG. 10, in which rigidities of high-rigidity lines 52a, 52b, 53a, and 53b of first and second hydraulic lines 52-53 are designed or set to be remarkably greater than those of low-rigidity lines 52c and 53c, the expanded volume of each of high-rigidity lines 52a, 52b, 53a, and 53b tends to become negligibly smaller than that of each of low-rigidity lines 52c-53c, during the steering-assist mode. For the reasons discussed above, even when the line lengths of first and second hydraulic lines 52-53 differ from each other, it is possible to almost equalize apparent volume modulus Ke of working fluid in first hydraulic pressure transmission path 60 and apparent volume modulus Ke of working fluid in second hydraulic pressure transmission path 61, by equalizing the material, cross-sectional form and line length of first low-rigidity line 52c with those of second low-rigidity line 53c. The other hydraulic system configuration of the power steering apparatus of the second embodiment of FIG. 10 is similar to the first embodiment of FIGS. 1-2. That is, in a similar manner to the first embodiment, in the power steering apparatus of the second embodiment, apparent volume modulus Ke of working fluid in the hydraulic pressure transmission path (each of first and second hydraulic pressure transmission paths 60-61) is set to be within a specified apparent volume modulus range, defined by an inequality 100 MPa≦Ke≦300 MPa.

Assume that the rigidities of the first and second hydraulic lines, associated with respective hydraulic chambers of the power cylinder, are not taken into account at all and additionally the settings of apparent volume moduli Ke1 and Ke2 of working fluid remarkably differ from each other, between the first and second hydraulic pressure transmission paths. In this case, the expanded volumes of the first and second hydraulic pressure transmission paths are different from each other, depending on the steering direction, during the steering-assist mode. That is, there is a remarkable difference between a degree of a response lag of the steering-assist control system to a rightward steering input and a degree of a response lag of the steering-assist control system to a leftward steering input. This also gives the driver an uncomfortable steering feel.

In contrast to the above, according to the power steering apparatus of the second embodiment shown in FIG. 10, apparent volume modulus Ke of working fluid in first hydraulic pressure transmission path 60 and apparent volume modulus Ke of working fluid in second hydraulic pressure transmission path 61 are set to be substantially identical to each other. Thus, there is a less difference between a degree of a response lag to a rightward steering input and a degree of a response lag to a leftward steering input. This contributes to the enhanced steering feel.

As set out above, according to the second embodiment shown in FIG. 10, apparent volume modulus Ke of working fluid in first hydraulic pressure transmission path 60 and apparent volume modulus Ke of working fluid in second hydraulic pressure transmission path 61 are set to be substantially identical to each other. The power steering apparatus of the second embodiment of FIG. 10 can provide the same operation and effects as the first embodiment of FIGS. 1-2. Additionally, even when the line lengths of first and second hydraulic lines 52-53 differ from each other, by the use of first and second low-rigidity lines 52c and 53c both having the same material, cross-sectional form and line length, it is possible to prevent or avoid the problem of the response lag remarkably affected by the steering direction, thus enhancing or improving a steering feel.

Furthermore, in the hydraulic system of the power steering apparatus of the second embodiment of FIG. 10, each of first and second hydraulic lines 52-53 is comprised of a plurality of lines (52a, 52c, 52b; 53a, 53c, 53b) having rigidities differing from each other. Therefore, the second embodiment has a merit that apparent volume modulus Ke of working fluid in first hydraulic pressure transmission path 60 and apparent volume modulus Ke of working fluid in second hydraulic pressure transmission path 61 can be easily equalized with each other, by equalizing the volume of first low-rigidity line 52c having the lowest rigidity among a plurality of lines 52a, 52c, and 52b constructing first hydraulic line 52 with the volume of second low-rigidity line 53c having the lowest rigidity among a plurality of lines 53a, 53c, and 53b constructing second hydraulic line 53.

In equalizing the volume of first low-rigidity line 52c having the lowest rigidity among the lines 52a, 52c, and 52b with the volume of second low-rigidity line 53c having the lowest rigidity among the lines 53a, 53c, and 53b, it is preferable to almost equalize the diameter and the line length of first low-rigidity line 52c of first hydraulic line 52 with those of second low-rigidity line 53c of second hydraulic line 53.

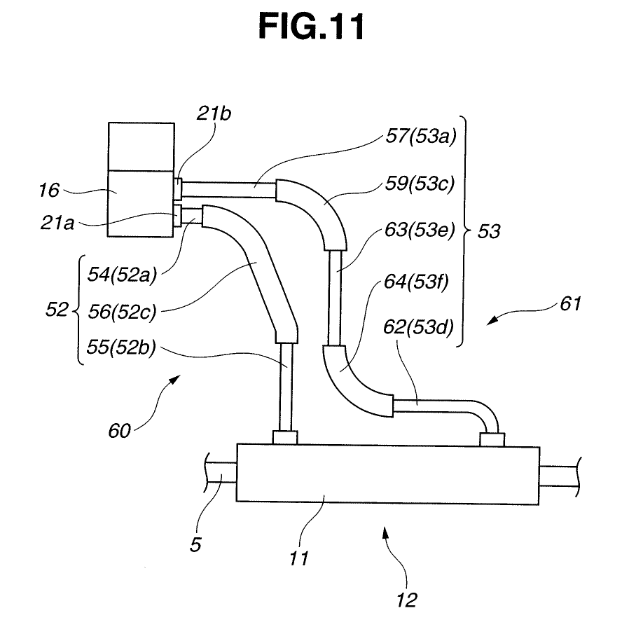

Referring to FIG. 11, there is shown the schematic layout of modified first and second hydraulic lines 52-53, both somewhat modified from the first and second hydraulic lines shown in FIG. 10. The modification of FIG. 11 is similar to the second embodiment of FIG. 10, except that the line length of first low-rigidity line 52c of the modification of FIG. 11 is somewhat longer than that of the second embodiment of FIG. 10, and the construction of second hydraulic line 53 of the modification of FIG. 11 is somewhat different from that of the second embodiment of FIG. 10. Thus, the same reference signs used to designate elements in the second embodiment shown in FIG. 10 will be applied to the corresponding elements used in the modification shown in FIG. 11, for the purpose of comparison of the second embodiment (see FIG. 10) and the modification (see FIG. 11).

As appreciated from comparison between the two schematic layouts of FIGS. 10-11, cylinder-side second high-rigidity line 53b of the second embodiment of FIG. 10 is replaced with three lines of the modification of FIG. 11, namely, a cylinder-side third high-rigidity line 53d, an intermediate high-rigidity line 53e, and a third low-rigidity line 53f. Cylinder-side third high-rigidity line 53d is formed of a substantially right-angled steel tube 62, which is bent toward the second hydraulic chamber 11b such that one end is connected to second hydraulic chamber 11b. Intermediate high-rigidity line 53e is formed of a substantially straight steel tube 63. Third low-rigidity line 53f is formed of a flexible tube (or an elastically deformable tube) 64, which is made of a synthetic rubber, that is, an elastomeric material (a polymeric material) having a rubber elasticity. Third low-rigidity line 53f serves as a variable volume section (a volume increase-and-decrease section) through which intermediate high-rigidity line 53c (the lower end of steel tube 63) and cylinder-side third high-rigidity line 53d (the other end of steel tube 62) are connected to each other. The lateral cross-section of first low-rigidity line 52c of the modification of FIG. 11 is equal to that of first low-rigidity line 52c of the second embodiment of FIG. 10. However, the longitudinal line length of first low-rigidity line 52c of the modification of FIG. 11 is dimensioned to be approximately two times longer than that of the second embodiment of FIG. 10, so that the summed value of the line lengths of second and third low-rigidity lines 53c and 53f, both included in second hydraulic line 53 and functioning as a volume increase-and-decrease section whose volume expands or contracts responsively to a change in the hydraulic pressure in second hydraulic pressure transmission path 61, is equal to the line length of first low-rigidity line 52c, included in first hydraulic line 52 and functioning as a volume increase-and-decrease section whose volume expands or contracts responsively to a change in the hydraulic pressure in first hydraulic pressure transmission path 60. The other hydraulic system configuration of the power steering apparatus of the modification of FIG. 11 is similar to the second embodiment of FIG. 10. That is, in a similar manner to the first (see FIGS. 1-2) and second (see FIG. 10) embodiments, in the power steering apparatus of the modification (see FIG. 11), apparent volume modulus Ke of working fluid in the hydraulic pressure transmission path (each of first and second hydraulic pressure transmission paths 60-61) is set to be within a specified apparent volume modulus range, defined by an inequality 100 MPa≦Ke≦300 MPa. In the modification of FIG. 11, it is possible to easily equalize apparent volume modulus Ke of working fluid in first hydraulic pressure transmission path 60 and apparent volume modulus Ke of working fluid in second hydraulic pressure transmission path 61 by equalizing the summed value of the line lengths of second and third low-rigidity lines 53c and 53f with the line length of first low-rigidity line 52c. Therefore, the modification of FIG. 11 can provide the same operation and effects as the power steering apparatus of the first and second embodiments. The fluid-line structure of first and second hydraulic lines 52-53 of the modification of FIG. 11 is superior to that of the second embodiment of FIG. 10, in increased layout flexibility. However, the fluid-line structure of first and second hydraulic lines 52-53 of the modification of FIG. 11 is inferior to that of the second embodiment of FIG. 10, in fewer fittings.

In the modification of FIG. 11, to provide a volume increase-and-decrease section (or a variable volume section) two low-rigidity lines, namely, second low-rigidity line 53c and third low-rigidity line 53f are disposed in second hydraulic line 53. On the other hand, in the second embodiment of FIG. 10, to provide a volume increase-and-decrease section, one low-rigidity line, namely, second low-rigidity line 53c is disposed in second hydraulic line 53. It will be appreciated that the number of low-rigidity lines, constructing a part of the hydraulic pressure transmission path, is not limited to one or two. In order to almost equalize apparent volume modulus Ke of working fluid in first hydraulic pressure transmission path 60 with apparent volume modulus Ke of working fluid in second hydraulic pressure transmission path 61, it is important and essential to substantially equalize the summed value of volumes of all low-rigidity lines, included in first hydraulic line 52, with the summed value of volumes of all low-rigidity lines, included in second hydraulic line 53.

The entire contents of Japanese Patent Application No. 2007-291408 (filed Nov. 9, 2007) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A power steering apparatus comprising:
a steering-assist hydraulic power cylinder having a first hydraulic chamber and a second hydraulic chamber divided by a piston;
a reversible pump configured to selectively supply working fluid to either one of the first and second hydraulic chambers of the power cylinder, while producing a pump pressure by pressurizing the working fluid;
a controller configured to control a driving state of the pump; and
a hydraulic circuit comprising:
(a) a first hydraulic line provided to connect the first hydraulic chamber and a first port of the pump, and cooperated with the first hydraulic chamber to construct a first hydraulic pressure transmission path through which the pump pressure is transmitted to a first pressure-receiving surface of the piston facing the first hydraulic chamber;
(b) a second hydraulic line provided to connect the second hydraulic chamber and a second port of the pump, and cooperated with the second hydraulic chamber to construct a second hydraulic pressure transmission path through which the pump pressure is transmitted to a second pressure-receiving surface of the piston facing the second hydraulic chamber; and
(c) a variable volume section disposed in each of the first and second hydraulic pressure transmission paths, a volume of the variable volume section being elastically varied responsively to a hydraulic pressure change in the associated hydraulic pressure transmission path,
wherein each of an apparent modulus of volume elasticity of working fluid in the first hydraulic pressure transmission path and an apparent modulus of volume elasticity of working fluid in the second hydraulic pressure transmission path is set to a value greater than or equal to 100 MPa, the apparent modulus of volume elasticity of working fluid in the first hydraulic pressure transmission path corresponding to a ratio of a hydraulic pressure change in the first hydraulic pressure transmission path to a rate of change in working fluid quantity in the first hydraulic pressure transmission path, the working fluid quantity change in the first hydraulic pressure transmission path including a change in volume of the first hydraulic pressure transmission path itself, occurring due to the hydraulic pressure change in the first hydraulic pressure transmission path, and the apparent modulus of volume elasticity of working fluid in the second hydraulic pressure transmission path corresponding to a ratio of a hydraulic pressure change in the second hydraulic pressure transmission path to a rate of change in working fluid quantity in the second hydraulic pressure transmission path, the working fluid quantity change in the second hydraulic pressure transmission path including a change in volume of the second hydraulic pressure transmission path itself, occurring due to the hydraulic pressure change in the second hydraulic pressure transmission path.

2. The power steering apparatus as claimed in claim 1, wherein:
each of the apparent modulus of volume elasticity of working fluid in the first hydraulic pressure transmission path and the apparent modulus of volume elasticity of working fluid in the second hydraulic pressure transmission path is set to a value less than or equal to 300 MPa.

3. The power steering apparatus as claimed in claim 1, wherein:
each of the first and second hydraulic pressure transmission paths comprises a high-rigidity line formed of a steel tube, and a low-rigidity line functioning as the variable volume section and formed of a flexible tube, which is made of a synthetic rubber.

4. The power steering apparatus as claimed in claim 1, wherein:
each of the apparent modulus of volume elasticity of working fluid in the first hydraulic pressure transmission path and the apparent modulus of volume elasticity of working fluid in the second hydraulic pressure transmission path is calculated by the following expression,
Ke=ΔP×V/ΔV
where ΔP denotes the hydraulic pressure change in each of the first hydraulic pressure transmission path and the second hydraulic pressure transmission path, V denotes the working fluid quantity in each of the first and second hydraulic pressure transmission paths before the hydraulic pressure change occurs, and ΔV denotes the working fluid quantity change in each of the first and second hydraulic pressure transmission paths, occurring due to the hydraulic pressure change in each of the first and second hydraulic pressure transmission paths.

5. The power steering apparatus as claimed in claim 1, wherein:
a hydraulic accumulator is interleaved in each of the first and second hydraulic lines as the variable volume section.

6. A power steering apparatus comprising:
a steering-assist hydraulic power cylinder having a first hydraulic chamber and a second hydraulic chamber divided by a piston;
a reversible pump configured to selectively supply working fluid to either one of the first and second hydraulic chambers of the power cylinder, while producing a pump pressure by pressurizing the working fluid;
a controller configured to control a driving state of the pump; and
a hydraulic circuit comprising:
(a) a first hydraulic line provided to connect the first hydraulic chamber and a first port of the pump, and cooperated with the first hydraulic chamber to construct a first hydraulic pressure transmission path through which the pump pressure is transmitted to a first pressure-receiving surface of the piston facing the first hydraulic chamber; and
(b) a second hydraulic line provided to connect the second hydraulic chamber and a second port of the pump, and cooperated with the second hydraulic chamber to construct a second hydraulic pressure transmission path through which the pump pressure is transmitted to a second pressure-receiving surface of the piston facing the second hydraulic chamber,
wherein each of the first and second hydraulic pressure transmission paths comprises a high-rigidity line formed of a steel tube, and a low-rigidity line formed of a flexible tube, which is made of a synthetic rubber, and
wherein each of a volume ratio of a volume of the low-rigidity line included in the first hydraulic pressure transmission path to a total volume of the first hydraulic pressure transmission path and a volume ratio of a volume of the low-rigidity line included in the second hydraulic pressure transmission path to a total volume of the second hydraulic pressure transmission path is set to a value less than or equal to 40%.

7. The power steering apparatus as claimed in claim 6, wherein:
each of the volume ratio of the volume of the low-rigidity line included in the first hydraulic pressure transmission path to the total volume of the first hydraulic pressure transmission path and the volume ratio of the volume of the low-rigidity line included in the second hydraulic pressure transmission path to the total volume of the second hydraulic pressure transmission path is set to a value greater than or equal to 10%.

8. The power steering apparatus as claimed in claim 7, wherein:
each of a line length of the low-rigidity line included in the first hydraulic pressure transmission path and a line length of the low-rigidity line included in the second hydraulic pressure transmission path is dimensioned to be longer than or equal to 200 millimeters.

9. The power steering apparatus as claimed in claim 6, wherein:
each of a line length of the low-rigidity line included in the first hydraulic pressure transmission path and a line length of the low-rigidity line included in the second hydraulic pressure transmission path is dimensioned to be shorter than or equal to 600 millimeters.

10. A power steering apparatus comprising:
a steering-assist hydraulic power cylinder having a first hydraulic chamber and a second hydraulic chamber divided by a piston;
a reversible pump configured to selectively supply working fluid to either one of the first and second hydraulic chambers of the power cylinder, while producing a pump pressure by pressurizing the working fluid;
a controller configured to control a driving state of the pump; and
a hydraulic circuit comprising:
(a) a first hydraulic line provided to connect the first hydraulic chamber and a first port of the pump, and cooperated with the first hydraulic chamber to construct a first hydraulic pressure transmission path through which the pump pressure is transmitted to a first pressure-receiving surface of the piston facing the first hydraulic chamber; and
(b) a second hydraulic line provided to connect the second hydraulic chamber and a second port of the pump, and cooperated with the second hydraulic chamber to construct a second hydraulic pressure transmission path through which the pump pressure is transmitted to a second pressure-receiving surface of the piston facing the second hydraulic chamber,
wherein an apparent modulus of volume elasticity of working fluid in the first hydraulic pressure transmission path and an apparent modulus of volume elasticity of working fluid in the second hydraulic pressure transmission path are set to be substantially identical to each other, the apparent modulus of volume elasticity of working fluid in the first hydraulic pressure transmission path corresponding to a ratio of a hydraulic pressure change in the first hydraulic pressure transmission path to a rate of change in working fluid quantity in the first hydraulic pressure transmission path, the working fluid quantity change in the first hydraulic pressure transmission path including a change in volume of the first hydraulic pressure transmission path itself, occurring due to the hydraulic pressure change in the first hydraulic pressure transmission path, and the apparent modulus of volume elasticity of working fluid in the second hydraulic pressure transmission path corresponding to a ratio of a hydraulic pressure change in the second hydraulic pressure transmission path to a rate of change in working fluid quantity in the second hydraulic pressure transmission path, the working fluid quantity change in the second hydraulic pressure transmission path including a change in volume of the second hydraulic pressure transmission path itself, occurring due to the hydraulic pressure change in the second hydraulic pressure transmission path.

11. The power steering apparatus as claimed in claim 10, wherein:
each of the apparent modulus of volume elasticity of working fluid in the first hydraulic pressure transmission path and the apparent modulus of volume elasticity of working fluid in the second hydraulic pressure transmission path is calculated by the following expression,
Ke=ΔP×V/ΔV
where ΔP denotes the hydraulic pressure change in each of the first hydraulic pressure transmission path and the second hydraulic pressure transmission path, V denotes the working fluid quantity in each of the first and second hydraulic pressure transmission paths before the hydraulic pressure change occurs, and ΔV denotes the working fluid quantity change in each of the first and second hydraulic pressure transmission paths, occurring due to the hydraulic pressure change in each of the first and second hydraulic pressure transmission paths.

12. The power steering apparatus as claimed in claim 11, wherein:
each of the first and second hydraulic lines comprises a plurality of lines having rigidities differing from each other; and
a volume of a low-rigidity line having the lowest rigidity among the plurality of lines constructing the first hydraulic line is substantially equalized with a volume of a low-rigidity line having the lowest rigidity among the plurality of lines constructing the second hydraulic line.

13. The power steering apparatus as claimed in claim 12, wherein:
a diameter and a line length of the low-rigidity line included in the first hydraulic line are substantially equalized with a diameter and a line length of the low-rigidity line included in the second hydraulic line.

14. The power steering apparatus as claimed in claim 13, wherein:
each of the low-rigidity line included in the first hydraulic line and the low-rigidity line included in the second hydraulic line is formed of a flexible tube, which is made of a synthetic rubber.

15. The power steering apparatus as claimed in claim 12, wherein:
each of a volume ratio of the volume of the low-rigidity line included in the first hydraulic line to a total volume of the first hydraulic pressure transmission path and a volume ratio of the volume of the low-rigidity line included in the second hydraulic line to a total volume of the second hydraulic pressure transmission path is set to a value less than or equal to 40%.

16. The power steering apparatus as claimed in claim 15, wherein:
each of the volume ratio of the volume of the low-rigidity line included in the first hydraulic line to the total volume of the first hydraulic pressure transmission path and the volume ratio of the volume of the low-rigidity line included in the second hydraulic line to the total volume of the second hydraulic pressure transmission path is set to a value greater than or equal to 10%.

17. The power steering apparatus as claimed in claim 16, wherein:
each of a line length of the low-rigidity line included in the first hydraulic line and a line length of the low-rigidity line included in the second hydraulic line is dimensioned to be longer than or equal to 200 millimeters and dimensioned to be shorter than or equal to 600 millimeters.

18. The power steering apparatus as claimed in claim 11, wherein:
each of the apparent modulus of volume elasticity of working fluid in the first hydraulic pressure transmission path and the apparent modulus of volume elasticity of working fluid in the second hydraulic pressure transmission path is set to a value greater than or equal to 100 MPa.

19. The power steering apparatus as claimed in claim 18, wherein:
each of the apparent modulus of volume elasticity of working fluid in the first hydraulic pressure transmission path and the apparent modulus of volume elasticity of working fluid in the second hydraulic pressure transmission path is set to a value less than or equal to 300 MPa.
